(19) United States
(12) Patent Application Publication
(10) Pub. No.: US 2011/0069093 A1
(43) Pub. Date: Mar. 24, 2011

(54) ELECTROPHORETIC DISPLAY DEVICE

(75) Inventors: LI-JIA YAN, Shenzhen City (CN); CHUN-WEI PAN, Tu-Cheng (TW); KUAN-HONG HSIEH, Tu-Cheng (TW)

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/780,951

(22) Filed: May 17, 2010

(30) Foreign Application Priority Data
Sep. 23, 2009 (CN) 200910307559.8

(51) Int. Cl. G09G 3/34; G09G 5/02

(52) U.S. Cl. 345/690; 345/107

(57) ABSTRACT

An electrophoretic display device includes an electrophoretic ink layer, a plurality of pixel electrodes and a plurality of TFTs (thin film transistors) formed on a lower substrate. Each pixel electrode is connected between one TFT and the electrophoretic ink layer, first path terminals of all of the TFTs are connected to a power source driver, control terminals of all of the TFTs are connected to a gate driver. A transparent electrode is formed between the upper substrate and the electrophoretic ink layer. The electrophoretic ink layer includes a plurality of tubular cavities connected between the transparent electrode and the pixel electrodes, each tubular cavity contains a plurality of charged pigment particles. When a TFT is turned on by the gate driver, the source driver applies a voltage to the pixel electrode corresponding to the TFT, then driving the charged pigment particles to move and the tubular cavity displays corresponding color.

### BACKGROUND

1. Related Applications

This application is related to copending applications entitled, “ELECTROPHORETIC DISPLAY DEVICE”, filed **** (Atty. Docket No. US29334)

2. Technical Field

The present disclosure relates to display devices and, more particularly, to an electrophoretic display device.

3. Description of Related Art

Electrophoretic effects are well known among scientists and engineers, wherein charged particles dispersed in a fluid or liquid medium move under the influence of an electric field. As an example of the application of the electrophoretic effects, engineers try to realize displays by using charged pigment particles that are dispersed and are contained in dyed solution arranged between a pair of electrodes. Under the influence of an electric field, the charged pigment particles are attracted to one of the electrodes, so that desired images will be displayed. The dyed solution in which charged pigment particles are dispersed is called electrophoretic ink, and the display using the electrophoretic ink is called an electrophoretic display (abbreviated as EPD). It is desirable to provide a new type of electrophoretic display device that can display images in purer colors.

### BRIEF DESCRIPTION OF THE DRAWINGS

The components in the drawings are not necessarily drawn to scale, the emphasis instead being placed upon clearly illustrating the principles of the electrophoretic display device. Moreover, in the drawings, like reference numerals designate corresponding parts throughout the several views.

FIG. 1 is a schematic, cross-sectional view showing an electrophoretic display device in accordance with an exemplary embodiment.

FIG. 2 is a schematic, planar view of the electrophoretic display device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

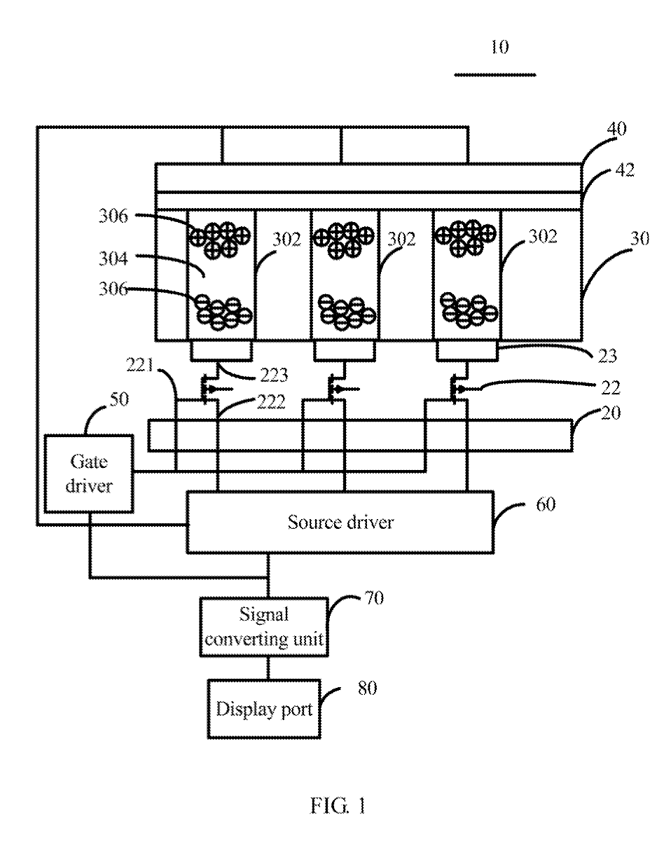

Referring to FIG. 1, an electrophoretic display device 10 includes a lower substrate 20, an electrophoretic ink layer 30, and an upper substrate 40. The electrophoretic ink layer 30 is arranged between the lower substrate 20 and the upper substrate 40, and is electrically connected to the upper substrate 40.

The lower substrate 20 can be made of plastic, or glass. A plurality of thin-film transistors (TFTs) 22 are located on the lower substrate 20, and a plurality of pixel electrodes 23 are connected between the electrophoretic ink layer 30 and the plurality of the TFTs 22, therein, each pixel electrode 23 is connected between one TFT 22 and the electrophoretic ink layer 30.

A transparent electrode 42 is formed between the upper substrate 40 and the electrophoretic ink layer 30, which corresponds to a display surface of the upper substrate 40 to be viewed by a person such as an operator. In the embodiment, the transparent electrode 42 is grounded and is used as a common electrode and can be made of indium tin oxide.

The electrophoretic ink layer 30 includes a plurality of tubular cavities 302. In the exemplary embodiment, the tubular cavities 31 are substantially parallel to each other and are substantially perpendicular to the lower substrate 20 and the upper substrate 40, and are arranged in a matrix pattern.

Each tubular cavity 302 is electrically connected between one pixel electrode 23 and the transparent electrode 42. Each tubular cavity 302 contains suspension fluid 304 and charged pigment particles 306 dispersed in the suspension fluid 304. The charged pigment particles 306 include black particles, red particles, green particles, and blue particles.

Applying a voltage to the pixel electrodes 23 forms a corresponding electric field between the pixel electrode 23 and the transparent electrode 42, the charged pigment particles 306 are driven to move to or away from the transparent electrode 42 to form images displayed on the electrophoretic display device 10.

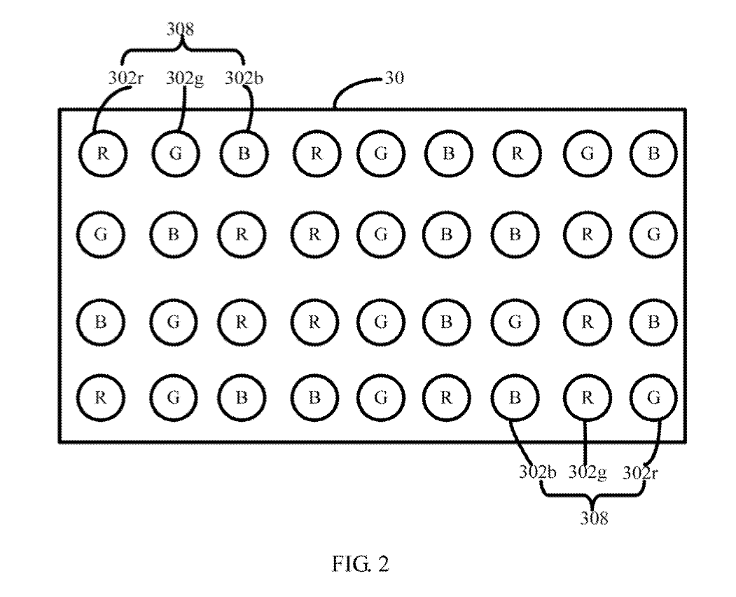

Referring to FIG. 2, the tubular cavities 302 are arranged in a matrix pattern and three tubular cavities 302r, 302g, and 302b constitute a pixel unit 308. Each of the tubular cavities 302r, 302g, and 302b contain red, green, and blue particles, respectively, and all of the tubular cavities 302 contain black particles. The manner of arrangement of the three tubular cavities 302r, 302g, and 302b are not limited. For example, as shown in FIG. 2, the tubular cavities 302r, 302g, and 302b are arranged from left to right in the pixel in the upper left corner, while the cavities 302b, 302r, and 302g are arranged from left to right in the pixel in the lower right corner.

The black particles have charge polarity opposite to charge polarity of the red particles, green particles, blue particles, in the embodiment, the red, green, and blue particles are positively charged and the black particles negatively charged. When a positive voltage is applied to the pixel electrode 23, the red, green, and blue particles are driven to move toward the transparent electrode 42. The black particles are driven to move toward the pixel electrodes 23, then the tubular cavities 302r, 302g, and 302b display red, green, and blue respectively viewed by a person from the display surface. When a negative voltage is applied to pixel electrode 23, the black particles are driven move toward the transparent electrode 42, and the red, green, and blue particles are driven to move toward the pixel electrodes 23, then the tubular cavities 302r, 302g, and 302b display black viewed by a person from the display surface.

Referring to FIG. 1 again, in the embodiment, the electrophoretic display device 10 also includes a gate driver 50 and a source driver 60.

Each TFT 22 includes a control terminal 221, a first path terminal 222, and a second path terminal 223, which terminals are connected to the gate driver 50, the source driver 60, and the pixel electrode 23, respectively. The gate driver 50 is used to turn on or off the TFT 22, the source driver 60 is used to provided power to the pixel electrode 23 connected to the TFT 22 that is turned on.

When the gate driver 50 turns on a TFT 22 the pixel electrode 23 connected to the TFT 22 is connected to the source driver 60 through the TFT 22. The source driver 60 applies a voltage to the pixel electrode 23 and causes the particles of the tubular cavity 302 corresponding to the pixel electrode 23 to move. The tubular cavity 302 thus displays corresponding color accordingly. For example, if a TFT 22 connected to the tubular cavity 302r is turned on and the source driver 60 applies a positive voltage to the pixel electrode 23, the red particles are driven to move toward the transparent electrode 42 and the tubular cavity 302r displays red color. If the source driver 60 applies a negative voltage to the pixel electrode 23, the black particles are driven to move toward the transparent electrode 42 and the tubular cavity 302r displays black.

Each pixel unit 308 can display different colors by applying different voltages to the cavities 302r, 302g, and 302b. The pixel unit 308 can thus display different colors by combining the colors displayed by the tubular cavities 302r, 302g, and 302b. For example, if tubular cavities 302r, 302g, and 302b of a pixel unit 308 displays red, green, and blue, respectively, then the pixel unit 308 displays a mixed color combined with red, green, and blue. If the tubular cavities 302r, 302g, and 302b of a pixel unit 308 display red, green, and black respectively, the pixel unit 308 displays a mixed color combined only with red and green. If the tubular cavities 302r, 302g, and 302b of a pixel unit 308 display red, black, and black respectively, the pixel unit 308 displays red. If the tubular cavities 302r, 302g, and 302b of a pixel unit 308 all display black, then the pixel unit 308 displays black accordingly.

In the embodiment, the tubular cavities 302r, 302g, and 302b can display colors of different levels by applying voltages with different amplitude. If the gate driver 50 turns on a TFT 22 connected to the tubular cavity 302 and the source driver 60 applies voltage with different amplitude to the pixel electrode 23. A different amount of particles are driven toward the transparent electrode 42 corresponding to the different voltage amplitude, and the tubular cavity 302 displays color of different level accordingly.

In other embodiments, a pulse width modulation driving method may be used. Specifically, by applying driving pulses of different pulse widths to the cavities 302r, 302g, and 302b, different amount of particles are driven toward the transparent electrode 42. In yet another embodiment, a pulse rate modulation driving method may be used. Specifically, by applying different numbers of driving pulses to each cavity 302r, 302g, and 302b, in a finite driving period that is the same for each of the cavities 302r, 302g, and 302b, different amount of particles are driven toward the transparent electrode 42.

Referring to FIG. 1 again, in the embodiment, the electrophoretic display device 10 further includes a signal converting unit 70 and a display port 80. The display port 80 is used to connect with and receive display signal from a computer or other electronic devices. The signal converting unit 70 is connected between the display port 80, the gate driver 50, and the source driver 60. The signal converting unit 70 is used to convert the display signal from the display port 80 to a control signal. In general, the display signal transmitted from the computer or other electronic devices includes clock signal and RGB signal. The signal converting unit 70 converts the clock signal to a scan signal and transmits the scan signal to the gate driver 50. The signal converting unit 70 also converts the RGB signal to an analog RGB signal and transmits the analog RGB signal to the source driver 60.

The gate driver 50 turns on corresponding TFTs according to the scan signal, and the source driver applies corresponding voltage to the pixel electrodes through the TFT that is turned on. Therefore, as described above, each pixel unit 308 displays corresponding color and all of pixel unit 308 form an image corresponding to the display signal.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electrophoretic display device comprising:
an upper substrate;
a lower substrate;
an electrophoretic ink layer electrically connected to the upper substrate, the electrophoretic ink layer comprising a plurality of tubular cavities, each tubular cavity comprising suspension fluid and charged pigment particles dispersed in the suspension fluid;
a transparent electrode connected between the upper substrate and the electrophoretic ink layer;
a plurality of thin-film transistors (TFTs) arranged on the lower substrate, each TFT comprising a control terminal, a first path terminal, and a second path terminal;
a plurality of pixel electrodes, each pixel electrode being connected between the second path terminal of one of the plurality of TFTs and one tubular cavity of the electrophoretic ink layer;
a gate driver connected to the control terminals of the plurality of TFTs, and configured for turning on or off one or more of the plurality of TFTs; and
a source driver connected to the first path terminals of the plurality of TFTs, and configured for applying voltage to the pixel electrodes corresponding to the TFTs that are turned on;
wherein, when the gate driver controls to turn on a TFT of the plurality TFTs and the source driver applies a voltage to the pixel electrode connected to the TFT, a corresponding electric field is formed between the pixel electrode and the transparent electrode and drives the charged pigment particles of a tubular cavity connected to the pixel electrode to move, and the tubular cavity displays a corresponding color.

2. The electroporetic display device according to claim 1, wherein each of the tubular cavities are formed perpendicular to the upper substrate and the lower substrate.

3. The electrophoretic display device according to claim 1, wherein three tubular cavities form a pixel unit, the three tubular cavities contain red particles, green particles, and blue particles respectively, and each of tubular cavities contains black particles.

4. The electrophoretic display device according to claim 3, wherein the black particles have charge polarity opposite to charge polarity of the red particles, green particles, blue particles.

5. The electrophoretic display device according to claim 1, wherein the transparent electrode is grounded and is made of indium tin oxide.

6. The electrophoretic display device according to claim 1, wherein the plurality of cavities are arranged in a matrix pattern.

7. The electrophoretic display device according to claim 1, wherein the lower substrate is made of glass or plastic.

8. The electrophoretic display device according to claim 1, wherein the electrophoretic display further comprises:
a display port, configured for connecting to and receiving display signal from an external electronic device; and
a signal converting unit, connected between the display port, the gate driver, and the source driver, and configured for converting the display signal received by the display port to a scan signal and an analog RGB signal, and transmitting the scan signal and the analog RGB signal to the gate driver and the source driver, respectively;
wherein, the gate driver turns on corresponding TFTs according to the scan signal, and the source driver provides corresponding voltage to the pixel electrodes through the TFTs that are turned on according to the RGB signal.
